(19) United States
(12) Patent Application Publication
(10) Pub. No.: US 2024/0069283 A1
(43) Pub. Date: Feb. 29, 2024

(54) TOOL FOR FORMING AN OPENING IN A JACKET OF A MULTI-FIBER CABLE CONFIGURED TO PROVIDE ENHANCED CUTTING MEMBER PROTECTION

(71) Applicant: Kim Lundgren ERIKSEN, Tappernøje (DK)

(72) Inventor: Kim Lundgren ERIKSEN, Tappernøje (DK)

(21) Appl. No.: 18/237,499

(22) Filed: Aug. 24, 2023

Related U.S. Application Data
(60) Provisional application No. 63/373,486, filed on Aug. 25, 2022.

(51) Int. Cl. G02B 6/245; B26B 29/06

(52) U.S. Cl. CPC G02B 6/245; B26B 29/06

(57) ABSTRACT

A tool for forming a window in a jacket of a cable includes a body portion having a first end, a second end opposite the first end, an exterior surface, a cable receiving portion extending from the first end to the second end, and an opening. The cable receiving portion may receive a cable having a jacket. A lower surface of the cable receiving portion may be curved in a region proximate to the opening in order to urge at least a portion of the jacket to extend beyond the exterior surface at the opening. The exterior surface and a guide member proximate to the opening are configured to allow a blade to slide across the opening to remove a portion of the jacket thereby providing access to a fiber or wire disposed within the jacket.

### CROSS REFERENCE TO RELATED APPLICATION

This application claims the benefit of U.S. Provisional Application No. 63/373,486 filed Aug. 25, 2022, pending, the disclosure of which is hereby incorporated by reference herein in its entirety.

### TECHNICAL FIELD

The present disclosure relates generally to tool for forming an opening in a multi-fiber cable. More particularly, the present disclosure is directed to a tool configured to form a window or opening in a jacket of a multi-fiber cable so that an individual fiber within the cable can be accessed via the window.

### BACKGROUND

Conventional window cutting tools for multi-fiber cables are designed to precisely cut a window in a multi-fiber cable. The window allows the individual fibers in the multi-fiber cable to be accessed, cut, and retracted from the cable. Such conventional tools typically grip and hold the cable in an arc profile so that a cut can be made in the jacket with a cutting blade without damaging the individual fibers in the cable.

Unfortunately, such conventional window cutting tools for fiber optic cable are designed to work with only one size of cable and cannot be adjusted for different cut depths. Thus, a technician needs to have a separate window cutting tool for each size cable that the technician works with. Further, such conventional window cutting tools are often inconsistent between cuts. For example, some cuts are too deep, which can damage the fibers in the cable, and some cuts are too shallow, which causes the technician to have to perform multiple cuts to create a desired window.

Therefore, it may be desirable to provide a window cutting tool that consistently and reliably cuts a window in a jacket of a multi-fiber cable without damaging the individual wires or fibers in the cable. It may be desirable to provide an inexpensive window cutting tool such that a separate tool can be provided for each cable size at a low cost.

### SUMMARY

The present disclosure provides a tool for forming a window in a jacket of a cable. The tool may include a body portion having a first end, a second end opposite the first end, an exterior surface, a cable receiving portion extending in a direction from the first end to the second end, and an access portion in the exterior surface configured to provide access to the cable receiving portion, a handle portion connected to the body portion, wherein the handle portion and the body portion are structurally configured as a monolithic structure of unitary construction, wherein the cable receiving portion is structurally configured to receive a cable, wherein the cable receiving portion includes a holding portion structurally configured to hold the cable in the cable receiving portion, wherein the body portion includes a cutting member receiving portion structurally configured to receive a cutting member, wherein the cutting member receiving portion includes a guide portion configured to guide movement of the cutting member relative to the access portion, wherein the access portion in the body portion is positioned at the guide portion, wherein the cable receiving portion includes a curved surface proximate to the access portion that is structurally configured to urge at least a portion of a jacket of the cable received in the cable receiving portion to extend through the access portion and beyond the guide portion, wherein the guide portion is structurally configured to guide a cutting member to slide across the guide portion to remove a portion of the jacket extending through the access portion when the cable is disposed in the cable receiving portion so as to create an opening in the jacket of the cable to provide access to a fiber or wire disposed within the jacket, wherein the cable receiving portion and the cutting member receiving portion are configured to provide a consistent size opening in the jacket of the cable and to prevent damage to the fiber or wire disposed within the jacket, wherein the cutting member receiving portion includes a cutting member protection portion at the first and second ends of the body portion and at a back wall that extend from the first end to the second end, and wherein the cutting member protection portion is configured to maintain the cutting member in the cutting tool receiving portion during operation of the tool so as to protect a user from being injured by the cutting member.

In yet another embodiment of the present disclosure, a tool for forming a window in a jacket of a cable may include a body portion having a first end, a second end opposite the first end, an exterior surface, a cable receiving portion extending in a direction from the first end to the second end, and an access portion in the exterior surface configured to provide access to the cable receiving portion, wherein the cable receiving portion is structurally configured to receive a cable, wherein the access portion is disposed in a cutting member receiving portion formed in the exterior surface of the body portion, wherein the access portion is positioned in a cutting member receiving portion, wherein the cable receiving portion is structurally configured to urge at least a portion of the jacket to extend beyond the exterior surface at the access portion, wherein the cutting member receiving portion includes a guide portion configured to guide movement of the cutting member relative to the access portion, wherein the cutting member receiving portion includes a cutting member protection portion structurally configured to protect the cutting member when the cutting member slides across the guide portion, wherein the guide portion is structurally configured to guide a cutting member to slide across the guide portion proximate to the access portion to remove a portion of the jacket so as to create an opening in the jacket of the cable to provide access to a fiber or wire disposed within the jacket, and wherein the guide portion is structurally configured to guide a cutting member to slide across the guide portion proximate to the access portion to remove a portion of the jacket so as to create an opening in the jacket of the cable to provide access to a fiber or wire disposed within the jacket.

In yet another embodiment of the present disclosure, a tool for forming a window in a jacket of a cable may include a body portion having a first end, a second end opposite the first end, an exterior surface, a cable receiving portion extending in a direction from the first end to the second end, and an access portion in the exterior surface configured to provide access to the cable receiving portion, a guide portion disposed proximate to the opening on the exterior surface, wherein the cable receiving portion is structurally configured to receive a cable, wherein the cable receiving portion is structurally configured to urge at least a portion of the jacket to extend beyond the exterior surface at the access portion, wherein the guide portion is structurally configured to guide a cutting member to slide across the guide portion to remove a portion of the jacket extending through the access portion so as to create an opening in the jacket to provide access to a fiber or wire disposed within the jacket, and wherein the body portion includes a cutting member protection portion structurally configured to protect the cutting member when the cutting member slides across the guide portion.

The foregoing and other features of construction and operation of the invention will be more readily understood and fully appreciated from the following detailed disclosure, taken in conjunction with accompanying drawings. Throughout the description, like reference numerals will refer to like parts in the various embodiments and drawing figures.

### BRIEF DESCRIPTION OF THE DRAWINGS

FIG. 1 is front view of an exemplary tool for cutting a window in a jacket of a cable.

FIG. 2 is a top isometric view of the tool of FIG. 1 with a cable in a channel of the tool.

FIG. 3 is a top isometric view of the tool of FIG. 1 with a blade positioned to slide across an upper portion of the cable along tracks of the tool.

FIG. 4 is a top isometric view of the tool of FIG. 1 after a portion of the jacket of the cable jacket has been removed by the blade.

FIG. 5 illustrates the cable shown in FIG. 4 with a window permitting access to the fibers in the cable,

FIG. 6A is a first side view of the tool of FIG. 1.

FIG. 6B is a second side view of the tool of FIG. 1.

FIG. 7A is an enlarged side view of a portion of the tool of FIG. 6B.

FIG. 7B is a vertical cross-sectional view of the tool of FIG. 1.

FIG. 7C is an enlarged partial cross-sectional view of the tool of FIG. 7B.

FIG. 7D is a bottom perspective view of the tool of FIG. 1.

FIG. 8 is a cross sectional view of the tool of FIG. 1 with the cable in the channel of the tool.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

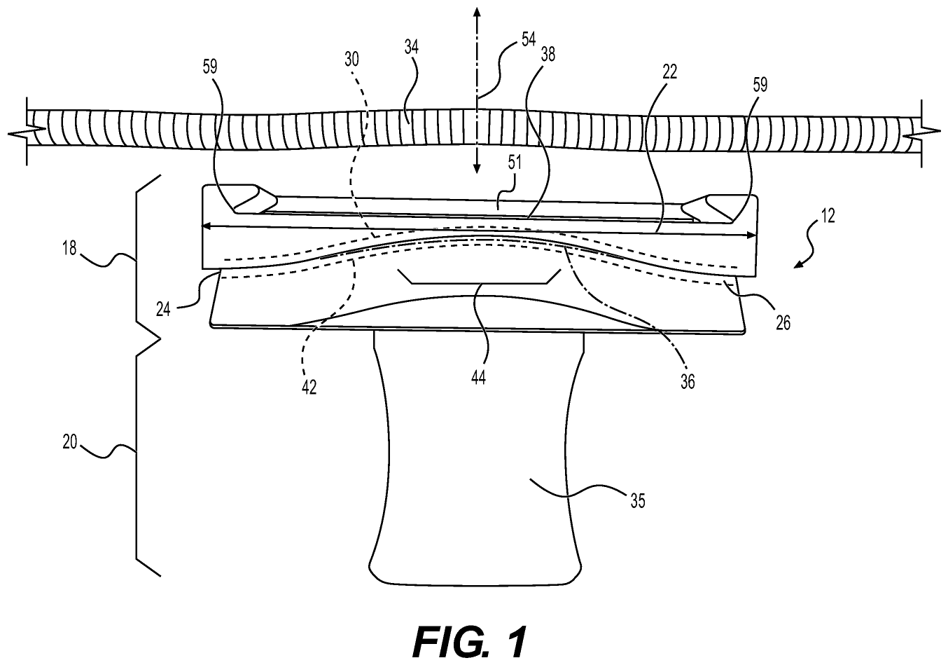

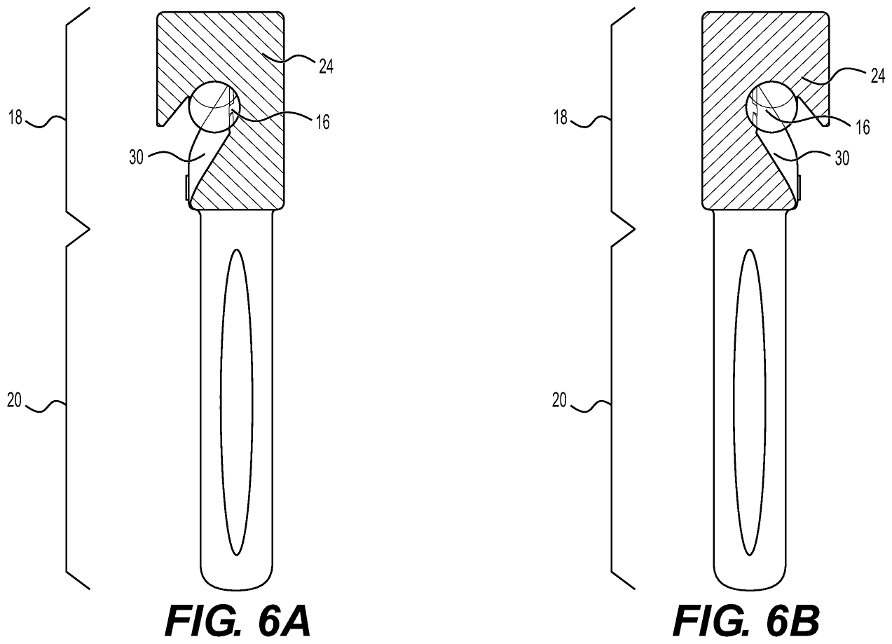

Referring to FIGS. 1-8, the present disclosure provides a tool 12, for example, a handheld tool, for forming a window or opening 14 in a jacket 34 of a cable 16, for example, a multi-fiber cable, by shaving, slitting, or cutting the jacket 34. In some aspects, the tool 12 may be used to form an opening in a duct that contains one or more cables, for example, fiber optic cables.

Referring in particular to FIG. 1, the tool 12 may include a first portion 18, which may be a body portion 18. In some embodiments, the tool may optionally include a second portion 20, which may be a handle or gripping portion 20, disposed substantially perpendicular to the first portion 18. The first portion 18 may have a length 22, a first end 24, a second end 26 opposite the first end 24, an exterior upper surface 28, a channel or cable receiving portion 30 extending in a direction from the first end 24 to the second end 26 along the length 22 of the first portion 18, and an opening or access portion 32 configured to provide access to the channel 30. The second portion 20 may be integral to the first portion 18 and may be configured to be a handle 35 for manual use. That is, the first portion 18 and the second portion 20 may be a monolithic structure (i.e., single piece) of unitary construction. In some aspects, the first portion 18 and the second portion 20 may be manufactured as separate elements and subsequently integrally connected to one another via any conventional means.

The channel 30, or cable receiving portion, may be configured to receive a cable 16 having a jacket 34. In some embodiments, the channel 30 may be an arcuate curve 36 between the first end 24 and the second end 26. The arcuate curve 36 may curve in a direction towards the opening 32. The first portion 18 may be integral to the second portion 20, and the first portion 18 and the second portion 20 may be formed from a polymeric material, a metallic material, or any other suitable material. The opening 32 may be defined in an exterior top surface 38, described in more detail below. In some embodiments, the opening 32 may be disposed between or within a guide portion that may comprise a track or guide member 40 on the exterior top surface 28. In some embodiments, the guide portion may comprise a pair of guide members 40 disposed on opposite sides of the opening 32 and may extend in a lengthwise direction of the opening 32. The guide members 40 may have a height that is raised from the exterior top surface 28.

In some embodiments, the exterior top surface 28 may include a recessed portion or cutting member receiving portion 52 defined in the exterior top surface 28 of the first portion 18. The recessed portion 52 may be defined by a back wall 51, first and second end walls 53, and the exterior top surface 38, with the guide members 40 disposed on the exterior top surface 38 of the recess 52 between the first and second end walls on both sides of the opening 42. The guide members 40 may extend upwards from the exterior top surface 38.

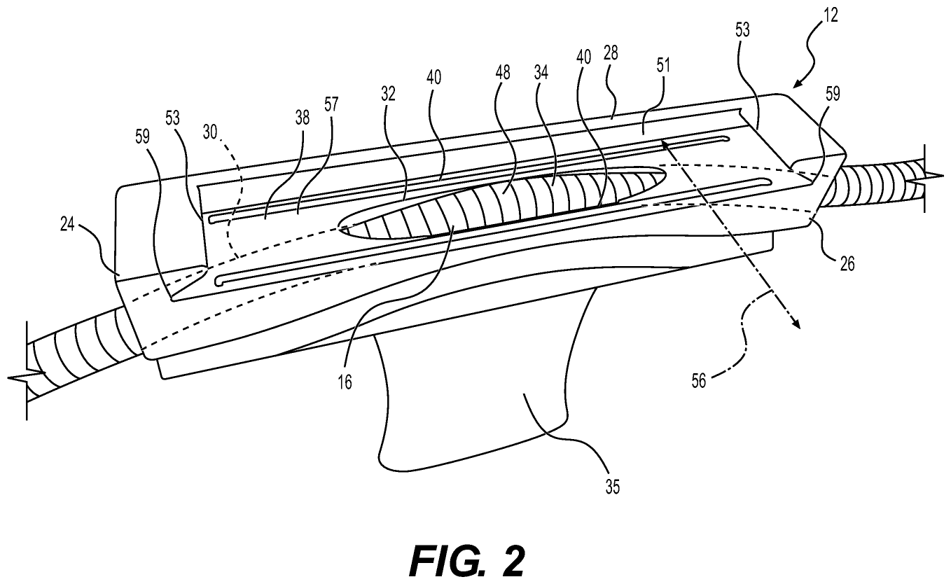

A lower surface (or edge) 42 of the channel 30 may be curved in a region 44 proximate to the opening 32 (see FIGS. 1 and 8) in order to urge at least a portion 48 of the jacket 34 of the cable 16 to extend through the opening 32 beyond the exterior top surface 38 of the recess 52. (See FIGS. 2-4 and 8).

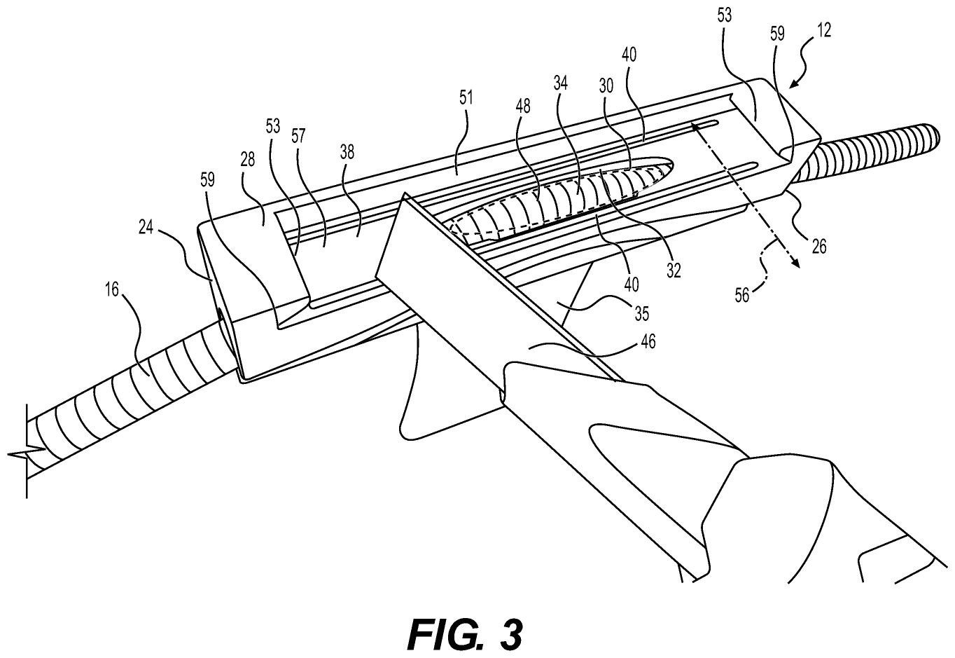

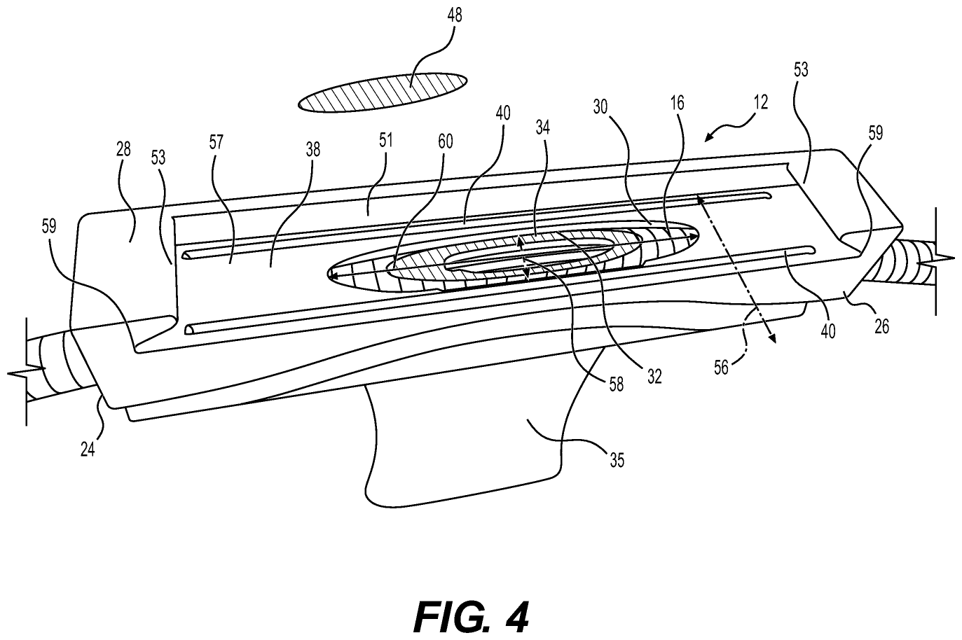

As shown in FIGS. 3 and 4, the first portion 18 may be configured to allow a blade, cutting member, or cutting tool 46 to slide across the guide portion, for example, the pair of guide members 40, and the opening 32 to remove a portion 48 of the jacket 34 when the cable 16 is disposed in the channel 30 thereby forming the opening 14 in cable 16 to provide access to a fiber or fibers (or wires) 50 disposed within the jacket 34. In this embodiment, the guide members 40 may be formed from a metal or other suitable material configured to be resistant to damage from the blade, cutting member, or cutting tool 46. The guide members 40 may alternatively be formed from a polymeric material and may be integral to the first portion 18. The recessed portion 52 may be accessible from a top direction 54 and a side direction 56 as shown in FIGS. 1 and 2.

The guide members 40 may be configured to extend upwards from the exterior top surface 38 of the recessed portion 52. A distance that the guide members 40 extend upwards from the exterior top surface 38 may be set so that when the blade or cutting tool 46 is slid across the guide members 40 to cut the opening 14 in the jacket 34 of the cable 16, the cutting tool 46 will not cut the fibers or wires 50 inside the jacket 34 of the cable 16.

The cable receiving portion 30 may be configured with a curvature configured to urge the jacket 34 of the cable 16 to extend through the opening 32 a sufficient distance to allow the jacket to be cut without cutting the wires 50 within the jacket 34.

In any of the embodiments that include the recessed portion 52, the side walls and the back wall of the recess 52 may be structurally configured to guide the blade or cutting tool 46 within the recess 52 along the portion of the cable 16 extending through the opening 32 to cut the jacket 34. The side and back walls of the recess 52 may also be structurally configured to contain the blade or cutting tool 46 within the recess 52 when the jacket 34 is being cut, which can prevent the blade or cutting tool 46 from injuring an operator or others.

In any of the embodiments that include the recessed portion 52, the back walls and side walls of the recess 52 may be configured to receive the cutting blade 46 and may be configured to define blade protection portions 57 that that protect the cutting blade 46 and prevent a user from being cut by the cutting blade 46 during operation of the tool. The blade protection portions 57 may include notches 59 formed in the side walls configured to receive the cutting blade 46 to protect the cutting blade 46.

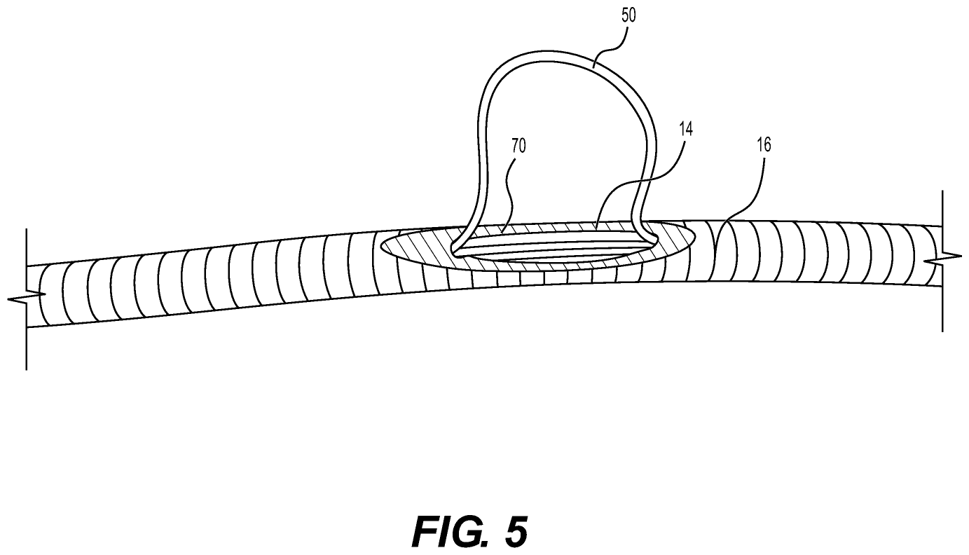

In yet another embodiment of the present disclosure, a tool 12 for forming a window 14 in a jacket 34 of a cable 16, for example, a multi-fiber cable, by shaving, slitting, or cutting the jacket 34. The tool 12 may include a first or body portion 18 and an optional second or handle portion 20 disposed perpendicular to the first portion 18 wherein the first portion 18 may include a length 22, a first end 24, a second end 26 opposite the first end 24, an exterior surface 28, a channel 30 extending in a direction from the first end 24 to the second end 26, and an opening 32 configured to provide access to the channel 30. See FIGS. 1-4. The second portion 20 may be integral to the first portion 18 and may be configured to be a handle 34 for manual use. The channel 30 may be configured to receive a cable 16 having a jacket 34. The channel 30 may form an arcuate curve 36 between the first end 24 and the second end 26. A lower surface 42 of the channel 30 may be curved in a region 44 proximate to the opening 32 in order to urge at least a portion 48 of the jacket 34 or cable 16 to extend beyond the exterior surface 28 at the opening 32. (See FIG. 8). The exterior surface 28 proximate to the opening 32 may be configured to allow a blade or cutting tool 46 to slide across the opening 32 to remove a portion 48 of the jacket 34 thereby providing access to one or more fibers or wires 50 disposed within the jacket 34 through aperture 70 (see FIG. 5).

In this embodiment, it is understood that the opening 32 may define a width 58 and a length 60 perpendicular to the width 58 wherein the length 60 may be greater than the width 58. (See FIG. 2). However, it is also understood that the width 58 may be equal in length to the length 60. Also, it is understood that the length 60 may be less than the width 58. The first or body portion 18 and the second portion 20 of the tool form may form a one-piece, monolithic structure. The opening 32 may be defined in an exterior top surface 28 or in an exterior top surface 38 of the recess 52 such that the opening 32 may be disposed between a pair of tracks or guide members 40. The exterior top surface 38 and the opening 32 may, but not necessarily, be disposed within the recess 52 defined in the first or body portion 18. The first portion or body 18 and the second portion 20 may be formed from a polymeric or other suitable material. The pair of guide members 40 may be metal or another suitable material. The recess 52 may be accessible from a top direction 54 and a side direction 56.

In yet another embodiment of the present disclosure, a tool 12 for forming a window 14 in a jacket 34 of a cable 16, for example, a multi-fiber cable, by shaving, slitting, or cutting the jacket 34. The tool 12 may include a first or body portion 18 and a second or handle portion 20 disposed perpendicular to the first or body portion 18 wherein the first or body portion 18 may include a length 22, a first end 24, a second end 26 opposite the first end 24, an exterior surface 28, a channel 30 extending from the first end 24 to the second end 26, and an opening 32 configured to provide access to the channel 30. The channel 30 may be configured to receive a cable 16 having a jacket 34. A lower surface 42 of the channel 30 may be curved in a region 44 proximate to the opening 32 in order to urge at least a portion 48 of the jacket 34 of the cable 16 to extend beyond the exterior top surfaces 28 or 38 within the opening 32. (See FIG. 8). The exterior top surface 28, 38 proximate to the opening 32 may be configured to allow a blade 46 to slide across the opening 32 to remove a portion 48 of the jacket 34 thereby providing access to one or more fibers or wires 50 disposed within the jacket 34.

In this embodiment, the channel 30 may be an arcuate curve 36 between the first end 24 and the second end 26. The opening 32 may define a width 58 and a length 60 perpendicular to the width 58 wherein the length 60 may be greater than the width 58. The second portion 20 may be integral to the first portion 18 and may be configured to be a handle 35 for manual use. The first portion 18 and the second portion 20 may form a monolithic structure.

In this embodiment, it is understood that a pair of tracks or guide members 40 may be disposed on an exterior top surface 28, 38 wherein the opening 32 is defined in the exterior top surface 28 or 38 such that the opening 32 is disposed between the pair of guide members 40 that may be formed from metal, polymeric or other suitable material. The exterior top surface 38, the pair of guide members 40 and the opening 32 are disposed within a recess 52 defined in the first or body portion 18. The first or body portion 18 and the second or handle portion 20 are formed from a polymeric material. the pair of tracks 40 are metal. The recess 52 may be accessible from a top direction 54 and a side direction 56.

With respect to the various embodiments of the present disclosure, it is understood that the tool may include multiple channels wherein each channel is accessible through a window similar to the channel described above. The channels may be adjacent to each other in a sideways direction 56 (see FIG. 4). Also, with respect to the various embodiments of the present disclosure, it is understood that the width 58 of the window may, but not necessarily, be equal in length to the length 60. Also, it is understood that the length 60 may, but not necessarily, be less than the width 58, and/or the length 60 may, but not necessarily, be greater than the width 58.

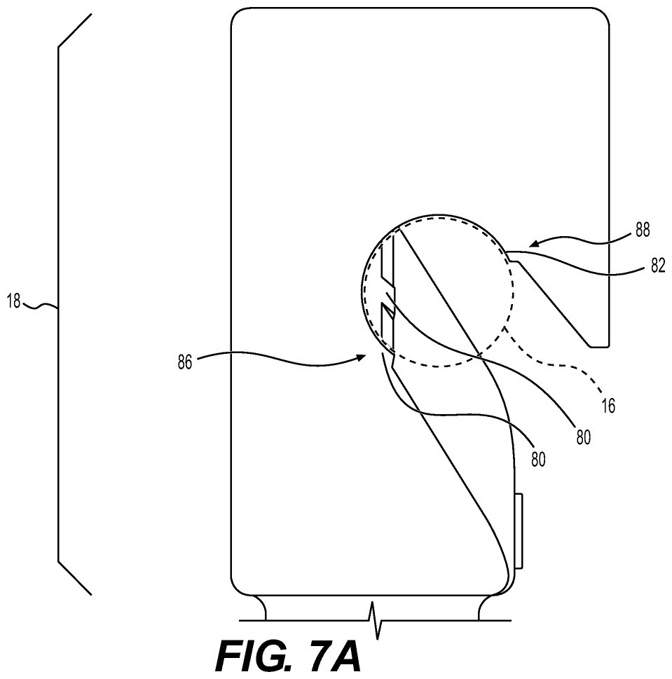

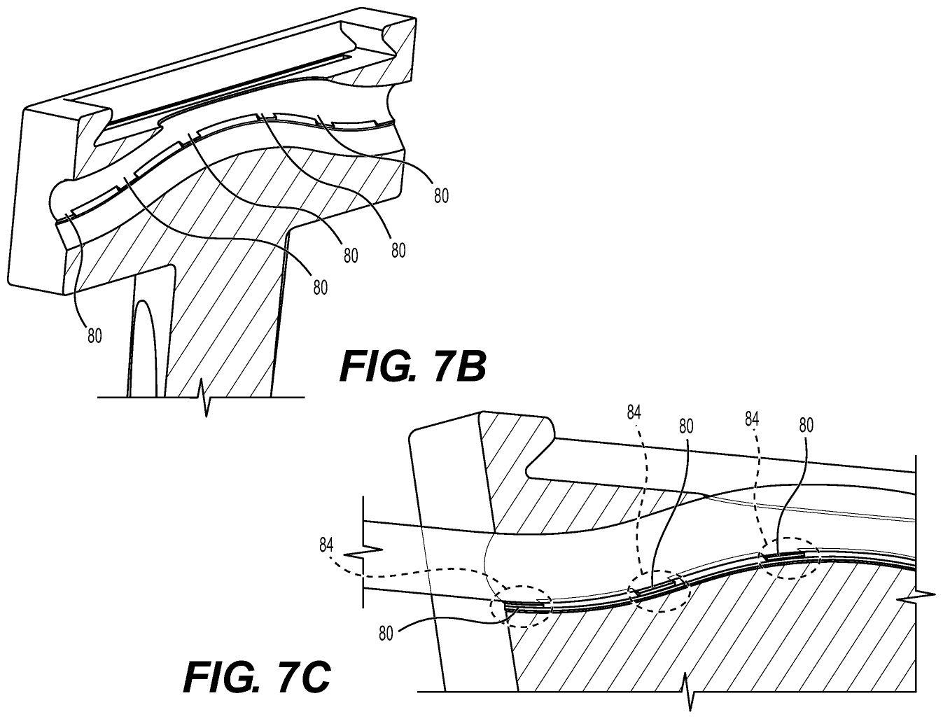

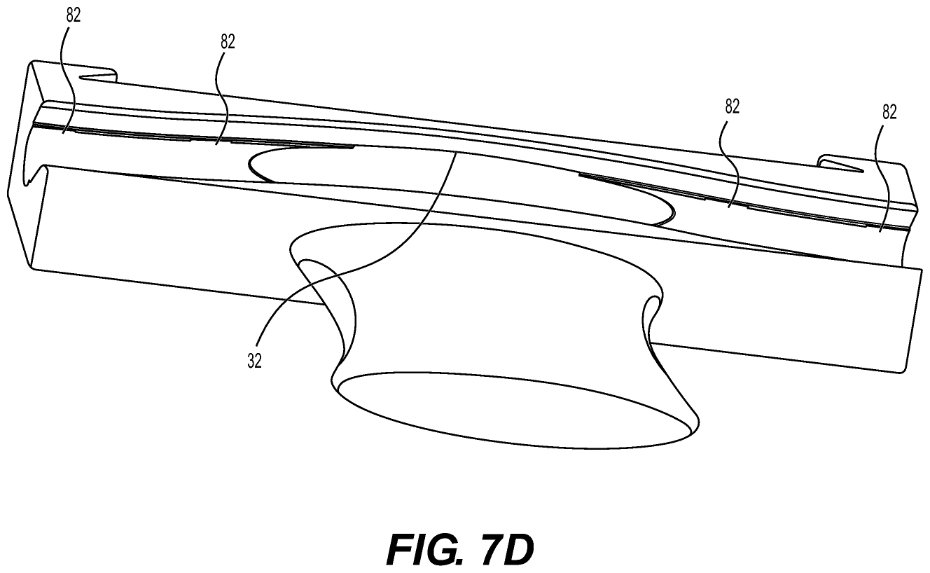

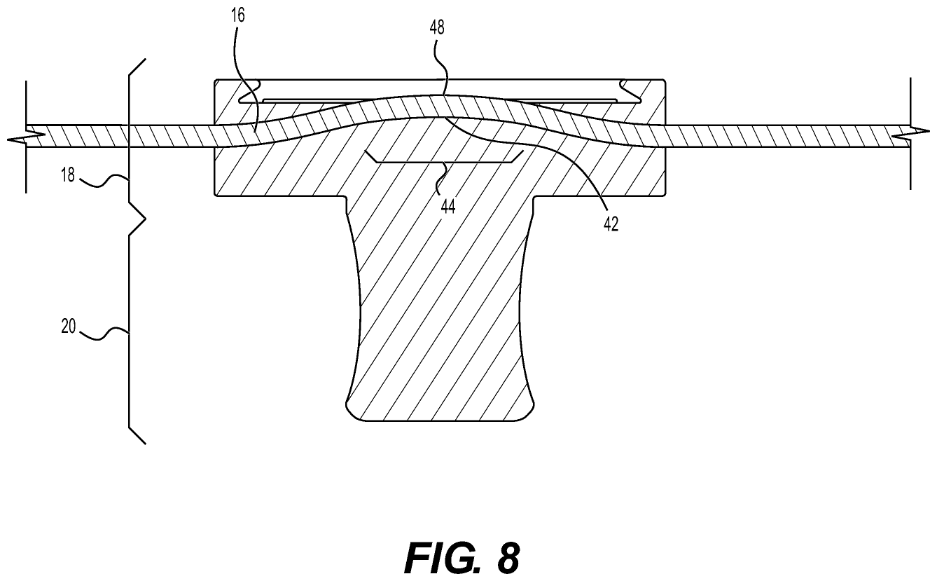

Also, referring now to FIGS. 7A-7D, with respect to various embodiments of the present disclosure, the tool may include a retaining portion 180 configured to hold the cable 16 in the channel 30. The retaining portion 180 may include one or more tabs 80, 82 in the channel 30, which may include lower tabs 80 provided in a lower region 86 (see FIG. 7A) of the channel 30 to support a lower region 84 of the cable 16 and/or upper tabs 82 provided in an upper region 88 (see FIG. 7A) of the channel 30 to secure the cable 16 in the channel 30. The upper tabs 82 and the lower tabs 80 may be structurally configured to work together to provide an interference fit between the cable 16 and the channel 30 such that the cable 16 stays in position in the channel 30. This retaining portion 180 is structurally configured to prevent the cable 16 from sliding in a direction between the first end 24 and the second end 26 as the blade 46 cuts away a portion of the jacket 34 of the cable 16 to create the window 14. Therefore, the channel 30 may include one or more of the upper tabs 82 and one or more of the lower tabs 80 that are structurally configured to secure the cable 16 within the channel 30.

While multiple exemplary, non-limiting embodiments have been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A tool for forming a window in a jacket of a cable comprising:
a body portion having a first end, a second end opposite the first end, an exterior surface, a cable receiving portion extending in a direction from the first end to the second end, and an access portion in the exterior surface configured to provide access to the cable receiving portion;
a handle portion connected to the body portion;
wherein the handle portion and the body portion are structurally configured as a monolithic structure of unitary construction;
wherein the cable receiving portion is structurally configured to receive a cable;
wherein the cable receiving portion includes a holding portion structurally configured to hold the cable in the cable receiving portion;
wherein the body portion includes a cutting member receiving portion structurally configured to receive a cutting member;
wherein the cutting member receiving portion includes a guide portion configured to guide movement of the cutting member relative to the access portion;
wherein the access portion in the body portion is positioned at the guide portion;
wherein the cable receiving portion includes a curved surface proximate to the access portion that is structurally configured to urge at least a portion of a jacket of the cable received in the cable receiving portion to extend through the access portion and beyond the guide portion;
wherein the guide portion is structurally configured to guide a cutting member to slide across the guide portion to remove a portion of the jacket extending through the access portion when the cable is disposed in the cable receiving portion so as to create an opening in the jacket of the cable to provide access to a fiber or wire disposed within the jacket;
wherein the cable receiving portion and the cutting member receiving portion are configured to provide a consistent size opening in the jacket of the cable and to prevent damage to the fiber or wire disposed within the jacket;
wherein the cutting member receiving portion includes a cutting member protection portion at the first and second ends of the body portion and at a back wall that extend from the first end to the second end; and
wherein the cutting member protection portion is configured to maintain the cutting member in the cutting tool receiving portion during operation of the tool so as to protect a user from being injured by the cutting member.

2. The tool of claim 1, wherein the guide portion is structurally configured to allow the cutting member to cut the jacket of the cable without cutting the fiber or wire within the jacket.

3. The tool of claim 2, wherein the guide portion is elevated from an upper surface of the cutting member receiving portion.

4. The tool of claim 1, wherein the cutting member receiving portion is accessible from a top direction and a side direction.

5. The tool of claim 1, wherein the cutting member receiving portion is structurally configured to control a position of the cutting member when the cutting member is cutting the jacket of the cable.

6. The tool of claim 1, wherein the holding portion includes a plurality of tabs structurally configured to secure the cable in the channel receiving portion.

7. A tool for forming a window in a jacket of cable, comprising:
a body portion having a first end, a second end opposite the first end, an exterior surface, a cable receiving portion extending in a direction from the first end to the second end, and an access portion in the exterior surface configured to provide access to the cable receiving portion;
wherein the cable receiving portion is structurally configured to receive a cable;
wherein the access portion is disposed in a cutting member receiving portion formed in the exterior surface of the body portion;
wherein the access portion is positioned in a cutting member receiving portion;
wherein the cable receiving portion is structurally configured to urge at least a portion of the jacket to extend beyond the exterior surface at the access portion;
wherein the cutting member receiving portion includes a guide portion configured to guide movement of the cutting member relative to the access portion;
wherein the cutting member receiving portion includes a cutting member protection portion structurally configured to protect the cutting member when the cutting member slides across the guide portion; and
wherein the guide portion is structurally configured to guide a cutting member to slide across the guide portion proximate to the access portion to remove a portion of the jacket so as to create an opening in the jacket of the cable to provide access to a fiber or wire disposed within the jacket.

8. The tool of claim 7, wherein the guide portion is structurally configured to allow the cutting member to cut the jacket of the cable without cutting the fiber or wire within the jacket.

9. The tool of claim 7, wherein the guide portion is elevated from an upper surface of the cutting member receiving portion.

10. The tool of claim 7, wherein the cutting member protection portion is disposed at the first and second ends of the body portion that extend in a direction from the first end to the second end.

11. The tool of claim 10, wherein the access portion is defined in the cutting member receiving portion.

12. The tool of claim 7, wherein the body portion formed from a polymeric material.

13. The tool of claim 7, wherein the guide portion is formed from a metallic material or a polymeric material.

14. The tool of claim 7, wherein the cutting member receiving portion is accessible from a top direction and a side direction.

15. The tool of claim 7, wherein the cutting member protection portion is disposed at the first and second ends of the body portion that extend in a direction from the first end to the second end.

16. A tool for forming a window in a jacket of a cable, the tool comprising:
a body portion having a first end, a second end opposite the first end, an exterior surface, a cable receiving portion extending in a direction from the first end to the second end, and an access portion in the exterior surface configured to provide access to the cable receiving portion;
a guide portion disposed proximate to the opening on the exterior surface;
wherein the cable receiving portion is structurally configured to receive a cable;
wherein the cable receiving portion is structurally configured to urge at least a portion of the jacket to extend beyond the exterior surface at the access portion;
wherein the guide portion is structurally configured to guide a cutting member to slide across the guide portion to remove a portion of the jacket extending through the access portion so as to create an opening in the jacket to provide access to a fiber or wire disposed within the jacket; and
wherein the body portion includes a cutting member protection portion structurally configured to protect the cutting member when the cutting member slides across the guide portion.

17. The tool of claim 16, wherein the channel is structurally configured to urge at least a portion of the jacket to extend beyond the exterior surface at the opening.

18. The tool of claim 16, wherein the access portion is disposed in a cutting member receiving portion formed in the exterior surface of the body portion.

19. The tool of claim 18, wherein the cutting member receiving portion includes an exterior upper surface, a back wall and a side wall that are structurally configured to control a position of the cutting member when the cutting member is cutting the jacket of the cable.

20. The tool of claim 16, wherein the guide members are elevated from an upper surface of the cutting member receiving portion.

21. The tool of claim 16, wherein the guide members are structurally configured to allow the cutting member to cut the jacket of the cable without cutting the fiber or wire within the jacket.

22. The tool of claim 16, wherein the securing member includes a plurality of tabs structurally configured to secure the cable in the channel.

23. The tool of claim 18, wherein the wherein the cutting member receiving portion is accessible from a top direction and a side direction.

24. The tool of claim 20, wherein the cutting member protection portion is disposed at the first and second ends of the body portion that extend in a direction from the first end to the second end.
